(19) United States
(12) Patent Application Publication
(10) Pub. No.: US 2013/0277136 A1
(43) Pub. Date: Oct. 24, 2013

(54) METHOD FOR UNOBTRUSIVE ADAPTATION TO ENABLE POWER STEERING IN VINTAGE CARS

(71) Applicant: Douglas Michael Young, Chandler QLD (AU)

(72) Inventor: Douglas Michael Young, Chandler QLD (AU)

(21) Appl. No.: 13/978,146

(22) PCT Filed: Jan. 3, 2012
(86) PCT No.: PCT/AU2012/000004

§ 371 Date: Jul. 3, 2013

Related U.S. Application Data
(60) Provisional application No. 61/429,186, filed on Jan. 3, 2011.

(51) Int. Cl. B62D 5/06

(52) U.S. Cl. CPC B62D 5/064
USPC 180/422; 29/825

(57) ABSTRACT

A retro-fittable power steering system for a vehicle; said system including an actuator acting on a component of the steering system of a said vehicle downstream of the steering box of said steering system; said system characterised in that said power steering system is activated manually under driver control; said system further characterised in that original steering components of said vehicle remain un-modified.

### TECHNICAL WIELD

The present invention relates to power assisted steering systems for vehicles and, more particularly for the retro-fitting of power steering systems to vintage and other older vehicle.

### BACKGROUND

Power steering in cars is well known and commonly applied in the art. While today most cars are fitted with power steering as standard, a lot of older cars did not have power steering fitted. Power steering was not commercially available in cars until 1951 when Chrysler brought out the Imperial model, with power steering. However the power steering option did not become mainstream until the late 1960's.

As a result a lot of older cars, which are not equipped with power steering are difficult to manoeuvre, especially at slow speeds. While standing still or moving slowly, the friction between the rubber tyres and the road surface produced by the weight of the vehicle makes it difficult to steer. Older cars are often much heavier than modern cars due to the use of heavier building materials. Because a growing number of vintage car owners are in their later years, this often means they are unable to drive the vintage car they own, due to the fact that they lack the strength to handle the steering. Similar concerns apply to the operation of the brakes and the clutch. These systems are quite elementary in vintage vehicles particularly and can be very heavy to operate.

Systems to retro-fit power steering to older cars are known in the art. Most commonly used are hydraulic, pneumatic and electric systems. Existing solutions are intrusive and require removal of original parts and fitting of replacement parts, or the cutting, adaptation and refitting of original parts. Often changes to the frame of the car need to be carried out in order to fit the additional components. When retro-fitting power steering to a vintage car, these rather intrusive and often damaging changes, as well as the removal of original parts, result in a depreciation in the value of the car.

One reason for this is that existing systems interpose the torque demand device into the steering column between the steering wheel and the steering mechanism. Many such systems also add the assistance force to the steering column which results in the steering mechanism gear box being required to transmit forces greater than those for which it was originally designed and resulting in a shortening of its operational lifespan.

As such, often a trade off needs to be made between the convenience of driving the car, and maintaining the car in its complete, original state with the aim of maintaining its monetary value.

It is an object of the present invention to address or ameliorate some of the above disadvantages.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general, knowledge of persons skilled in the art in any country.

### SUMMARY OF INVENTION

Accordingly, in a first broad form of the invention, there is provided a retro-fittable power steering system for a vehicle; said system including an actuator acting on a component of the steering system of a said vehicle; said system characterised in that said power steering system is activated manually under driver control; said system further characterised in that original steering components of said vehicle remain un-modified.

Preferably said system operates on steering components downstream of the steering box of said steering system

Preferably, components of said system are removably attached to said vehicle by clamping means.

Preferably, said system includes a torque/force sensing control module, a power source and said actuator.

Preferably, said torque/force sensing control module is mounted to, or adjacent to, a steering wheel of said vehicle.

Preferably, said power source comprises an electrical power supply source and an electro-hydraulic pump.

Preferably, said actuator is a double acting hydraulic cylinder; said cylinder mounted between a non-steering component and a steering component of said vehicle.

Preferably, an outer end of a piston rod of said double acting hydraulic cylinder is clamped to said steering component.

Preferably, a rear end of said hydraulic cylinder is pivotally attached to a fixture clamped to a chassis member of said vehicle.

Preferably, a rear end of said hydraulic cylinder is pivotally attached to a bracket extending from a front axle of said vehicle wherein the steerable wheels of said vehicle are not independently suspended and are connected by a rigid axle.

Preferably, said control module activates said reversible electro-hydraulic pump.

Preferably, said system further includes one way “check” valves which prevent hydraulic fluid escaping from said cylinder and a normally open hydraulic solenoid valve interconnecting respective hydraulic hoses between said electro-hydraulic pump and said double acting hydraulic cylinder.

Preferably, said electro-hydraulic pump and said double acting hydraulic cylinder form a closed circuit hydraulic system when said normally open solenoid valve is closed.

Preferably, said torque/force sensing control module provides for variable bi-directional speed control of said electro-hydraulic pump to provide respectively left and right turning of the front wheels of said vehicle; said control module biased towards a neutral default position in which electrical power is cut to said hydraulic pump and said normally open solenoid valve.

Preferably, said biasing towards a neutral position is such that the force applied to said module, tangentially to the steering wheel rim, determines the direction and speed of movement of said cylinder.

Preferably, an override switch maintains electrical power to said normally open solenoid valve; said valve then maintained in a closed position so as to lock said hydraulic cylinder into a partially or fully extended or partially or fully retracted position when turning a said vehicle at low speed.

In another broad form of the invention, there is provided a method of retro-fitting a power steering system to a steering system of a vehicle; the method including the steps of:

(a) mounting an actuator between a component of the steering system of said vehicle and an element of said vehicle other than a said component of said steering system,
(b) providing a manual control to activate a bi-directional power source for said double acting linear actuator,
and wherein all components of said system are attached to said steering component and said chassis by clamping means.
Preferably said actuator is a double acting linear actuator.

Preferably, said double acting linear actuator is a double acting hydraulic cylinder; said double acting hydraulic cylinder mounted between a chassis member and a track rod of said vehicle) extension and retraction of a piston rod of said hydraulic cylinder acting on said track rod to turn the front wheels of said vehicle when steering.

Preferably, said bi-directional power source is a variable speed electro-hydraulic pump; said pump and said double acting hydraulic cylinder forming an hydraulic circuit.

Preferably, said hydraulic circuit further includes a normally open solenoid valve; said solenoid valve providing a fluid passage between hydraulic hoses connecting said pump and said double acting hydraulic cylinder when said solenoid valve is in a default open position; said normally open solenoid valve closing when power is provided to said solenoid valve thereby creating a closed hydraulic circuit between said pump and said double action hydraulic cylinder.

Preferably, said variable speed electro-hydraulic pump is manually controlled by a control module; said control module operable in opposing directions so as to control extension and retraction of a piston rod of said double acting hydraulic cylinder acting on a track rod of said steering system.

In another broad form of the invention, there is provided a kit of components for retro-fitting a power steering system to a steering system of a vehicle so as to provide power steering for maneuvering said vehicle at low speed; said components including a control module, a power source, and a linear actuator.

Preferably, said power source comprises a reversible electro-hydraulic pump.

Preferably, said linear actuator comprises a double acting hydraulic cylinder.

Preferably, said control module for activating said power steering system; said control module providing manual control of speed and direction of said reversible electro-hydraulic pump.

Preferably, said components further include a normally open solenoid valve; said solenoid valve activated when said control module activates said power steering system; said solenoid valve when de-activated providing a by-pass of a hydraulic circuit between said reversible electro-hydraulic pump and said double acting hydraulic cylinder so as to relieve pressure in said double acting hydraulic cylinder.

In still another broad form of the invention, there is provided a power assistance system for vehicles; said system including a pressurised hydraulic fluid source and at least an hydraulic cylinder acting on a steering component of a said vehicle; said pressurised hydraulic fluid source providing power for assistance to operation of brakes and clutch of said vehicle.

Preferably said assistance is provided in addition to said steering system.

In another broad form of the invention, there is provided a power assistance system; said system including a torque/force sensing device.

Preferably said device is located at a rim of a steering wheel of a said vehicle.
Preferably said system is sensitive to tangential loads.
Preferably said system is sensitive to loads applied at said rim when turning said steering wheel.
Preferably said sensing device being part of a control module activating a linear actuator connected to a steering component of said vehicle.

Preferably, said actuator is a double acting hydraulic cylinder.

Preferably said hydraulic cylinder is provided with fluid pressure from a variable speed reversible electro-hydraulic pump.

Preferably, said sensing device includes a spinner knob deflectably attached to said rim of said steering wheel.

Preferably deflection of said spinner knob is relative said rim by a said tangential force applied by an operator of said vehicle, transferred to a potentiometer of said sensing device; said potentiometer providing an electrical output to a controller of said electro-hydraulic pump when said spinner knob is deflected from a default neutral position.

Preferably, an hydraulic circuit connecting said electro-hydraulic pump with said double acting hydraulic cylinder includes a normally open solenoid valve; said valve interposed between hydraulic lines connecting respective ports of said double acting hydraulic cylinder; said normally open solenoid valve retained in said normally open condition while said potentiometer remains in said default neutral position.

Preferably, degree and direction of said deflection determines speed and direction of rotation respectively of said electro-hydraulic pump.

Preferably deflection is relative to said rim.

Preferably, an override switch allows said normally open valve to be retained in a closed position; said double acting cylinder then locked in a fully or partially extended or retracted position to retain a desired steering direction of said vehicle.

### BRIEF DESCRIPTION OF DRAWINGS

Embodiments of the present invention will now be described with reference to the accompanying drawings wherein:

FIG. 1 is a plan view with partial enlargement of a typical steering mechanism of a solid front axle vintage motor vehicle,

FIG. 2 depicts components of a preferred embodiment of a retro-fittable power steering system for the vintage motor vehicle of FIG. 1,

FIG. 3 shows the components of FIG. 2 fitted to the vintage motor vehicle of FIG. 1,

FIG. 4 is an enlargement of a portion of FIG. 3,

FIG. 5 is a partial cross section of steering wheel showing a schematic arrangement of a spinner knob and potentiometer of a control module according to a preferred embodiment.

FIG. 6 is a plan view of the arrangement of FIG. 5.

### DESCRIPTION OF EMBODIMENTS

### First Preferred Embodiment

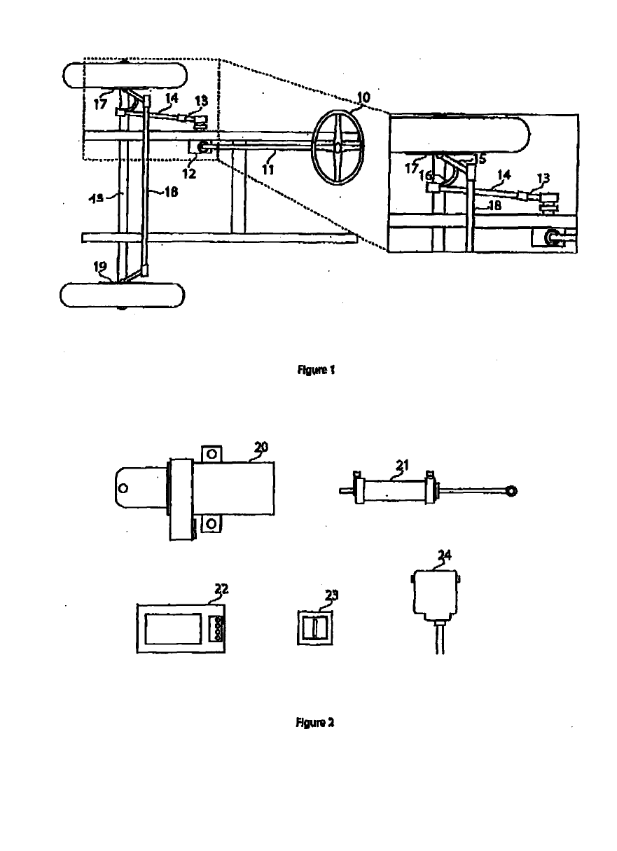

FIG. 1 shows an example of a vintage car steering system without any modifications. A steering wheel 10 is attached to a steering column 11. The steering column 11 connects to a gear system 12 which subsequently connects to an arm which is known as the Pitman arm 13. The Pitman arm 13 connects to the drag link 14 and the drag link 14 connects to the steering arm 15 (as shown in the enlargement of this section), via a ball joint 16. The steering arm 15 is connected to both the wheel assembly 17 and the track rod 18, which connects the other wheel assembly 19 and allows for simultaneous directional adjustment of both wheels 17, 19 through the steering assembly. While not shown in the drawings, the power assistance system(s) described below also require a direct current electrical power supply of the type already fitted to vehicles.

When the steering wheel 10 is rotated, the steering column 11 actuates the gear system 12, this in turn moves the Pitman arm 13, the drag link 14 and, via the ball joint 16, causes the steering arm 15 to rotate the wheels 17 and 19 left or right depending on the movement of the steering wheel 10.

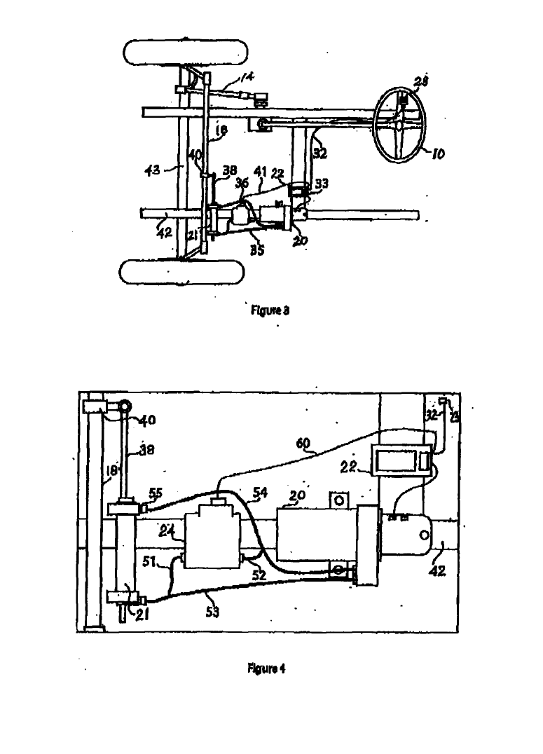

FIG. 2 shows the main components of the example embodiment. The existing vehicle steering system as shown in FIG. 1, remains unaltered. The system of the invention is added on, or connected to, the original steering assembly and vehicle chassis. In this preferred embodiment of the invention, the components comprise of a variable speed reversible electro-hydraulic pump 20, which can provide high pressure through the use of hydraulic oil in a closed circuit. The pump 20 can also incorporate one-way “check” valves to prevent flow of hydraulic fluid from the cylinder when the pump is not operating, thus allowing the cylinder to remain in a fixed position.

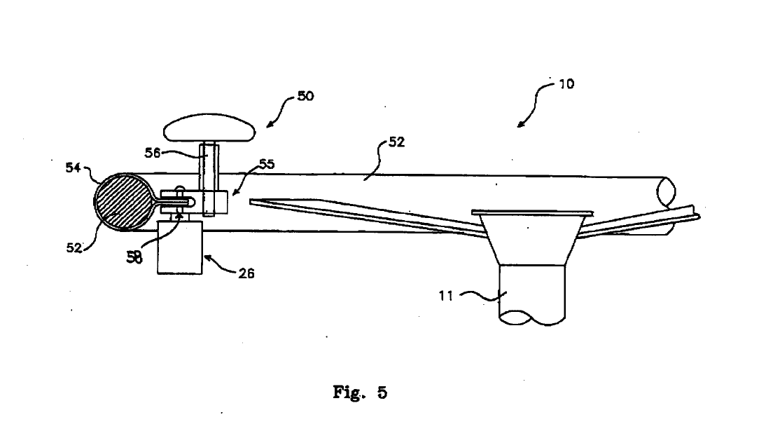

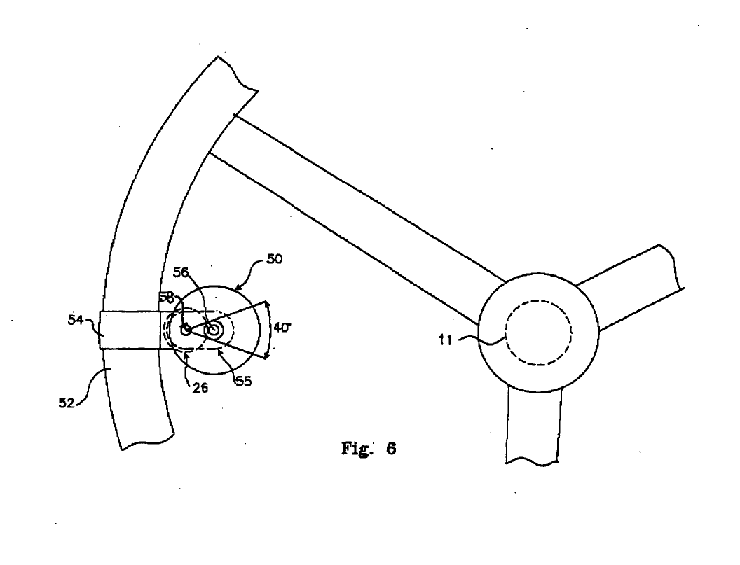

A linear actuator, preferably a double acting hydraulic cylinder 21 is used to create the movement needed to actuate the steering system. Its speed and direction of operation is determined by a torque/force demand sensor 23 mounted on the steering wheel, which transmits a signal to a variable speed bi-directional DC motor controller 22, which in turn controls the speed and direction of pumping of the pump 20. The torque/force demand sensor 23 includes a potentiometer (26 in FIG. 5), both of which are spring loaded to return to a central, neutral position (as with a potentiometer joy stick).

Preferably, the bi-directional DC motor controller 22 is a PWM (pulse width modulation) device controlled by the potentiometer 26. The potentiometer is biased to return to a default neutral position when no force is applied to it and, in this position, no current passes from the bi-directional motor controller 22 to the pump 20. The direction of rotation of the hydraulic pump 20 depends on the direction of movement of the potentiometer wiper from the default neutral position.

A normally open solenoid controlled valve 24 is fitted between, and in parallel with, the pump 20 and the cylinder 21 to provide an open hydraulic circuit when the system is not in use. This valve could be incorporated into the pump itself.

FIG. 3 shows the example embodiment fitted to the steering assembly of a car. The driver of the vehicle uses the control module 23 which incorporates a system activation switch to enliven the system, and a potentiometer to actuate the bi-directional DC motor controller 22. The control module 23 senses the torque assistance requirement and direction in which it is to be applied. The control module 23 and motor controller 22 are connected with low voltage electrical wiring 32. The bi-directional motor controller 22 transmits no current to the pump 20 when the potentiometer is at its mid position but on displacement from the mid position current is transmitted to the pump 20.

The bi-directional DC motor controller 22 is electronically wired 33 to the variable speed reversible electro-hydraulic pump 20 and operates the pump 20 with the instructions received from the control module 23.

When activated by the control module 23 via the DC controller 22, the pump 20 pumps hydraulic oil through attached hoses 35 and 36 to the double acting hydraulic cylinder 21. Depending on the direction in which the pump 20 pumps the fluid, the piston rod 38 of the cylinder 21 extends or retracts from a default half extended condition, causing the track rod 39 to displace laterally and operate the steering system. In one preferred arrangement, cylinder 21 is pivotally attached to a fixture clamped to the frame of the vehicle and the outer end of the cylinder rod 38 is connected to the track rod 39 using a clamp 40. By these means no alterations need to be made to the track rod 39 or to the chassis member 42. Alternatively, on some vehicles, the rear end of the double acting cylinder 21 may be attached to a bracket extending from one of the leaf spring pedestals (not shown) of the front axle 43, and using the leaf spring securing U bolts. Or again, the rear end of the cylinder may be attached to a bracket clamped directly to the front axle 43. By acting on the track rod 18, no additional force is applied on the steering box assembly avoiding any additional strain on the system.

Although in the above described arrangement the hydraulic cylinder 21 acts on the track rod 18, it will be understood that the system of the invention permits the cylinder 21 to act on other components of the steering system “downstream” of the steering column 11 and steering gear box 12. Thus an hydraulic cylinder could act on the drag link 14 or directly on the steering arm 15.

FIG. 4 shows a close-up of the hydraulic system, including the normally open solenoid control valve 24. This valve is inserted in the system, partly as a safety mechanism to prevent the system from locking up due to the pressure en in the cylinder 21 being maintained, but also to allow both manual and power assisted steering. An emergency, manually operated normally open, safety valve could be added, operable by, for example, an under-dash pull cable should the electrically operated valve fail to return to its normally open, default position when the current to the valve is removed by releasing the switch which enlivens the system.

The normally open solenoid control valve 24 is connected through two hoses 53. and 52 to the hoses 53 and 54 which connect the pump 20 and the cylinder 21. When an electric current is applied to the valve 24 it shuts, which creates a closed hydraulic circuit which enables the pump 20 to actuate the cylinder 21. The current is applied at the same time as the bi-directional DC motor controller 22 is activated, by means of valve 24 being interconnected by low voltage electrical wiring 60.

When no electric current is applied, the valve 24 returns to its open, default position, allowing for the unobstructed flow of fluid between the hoses 51 and 54 which allows the cylinder 21 to release pressure on the rod 38 which can now move freely with the track rod 18 when the steering is manually operated.

If one-way “check” valves are fitted to the pump body, when the system is enlivened, and the valve 24 is closed, but no force is being applied to the torque/force sensor 23, and no current is therefore applied to the pump 20, the hydraulic cylinder 21 will be fixed in its partially or fully extended or retracted position through the operation of the “check” valves. This allows low speed maneuvering of the vehicle to be performed with the steering on partial or full lock, without the necessity for electric current to be supplied to the pump 20. Normal manual control of the steering mechanism can be resumed at any time by releasing the system activation switch, which will open the valve 24.

When it is desired to move the steerable wheels from partial or full lock in one direction, this can be achieved either by releasing the valve 24 and operating the system manually, for example by allowing the self-centering characteristic of the manual steering to do so, or by using the pump 20 and cylinder 21 to do so.

In one preferred form the “Check” valves incorporated in the pump body may be solenoid valves, which are closed when the system is enlivened but no torque is applied to the torque/force sensor 23 and the pump therefore is not pumping.

Flow restrictors may be installed at the ports of the hydraulic cylinder so that when in deactivated mode the cylinder acts as a steering damper, damping jerking movements of the cylinder rod and hence of the vehicle steering in response to road surface bumps. Because such jerking movements can cause the onset of “shimmy” where the steerable front wheels can oscillate from side to side after hitting a bump, many vintage cars have had passive hydraulic dampers fitted.

By mounting the control module 23 on the steering wheel 10, the user receives immediate tactile feedback as to the amount by which the steerable wheels have been turned by the cylinder 21.

This control module 23 also senses the speed at which the operator wishes to turn the steering wheel 10 (and steering system) and via, the bi-directional controller operates the electro-hydraulic pump 20 at the desired variable speed.

### Second Preferred Embodiment

Instead of a reversible electro-hydraulic pump 20 which acts directly on the steering hydraulic cylinder, the system may employ an hydraulic pump maintaining pressure in a hydraulic reservoir (not shown). In this arrangement, the control module 23 and controller 22 act on an hydraulic control valve system which directs which of the hydraulic lines 35 or 36 are to be pressurized and with what rate of flow. The provision of an hydraulic reservoir may provide for the addition to an older vehicle of power assistance to the operation of the brakes and the clutch.

The hydraulic cylinders for providing assistance for clutch and brake operation would be placed so as to have the rearward part of the cylinders pivotally attached to a part of the vehicle frame or chassis, and the other end attached to a part of the clutch or brake mechanical components so as to supplement the force applied by the operator. The control system could be in the form of a force sensitive sensor on the clutch or brake pedal. This could comprise a plate attached to the surface of the pedal, pivoted at the lower end, with a spring between the upper end of the lever and the pedal, and when force is applied to the plate, the spring compresses and the relative movement between the plate and the pedal operates, eg, a potentiometer control device, which in turn operates the valve to admit hydraulic fluid to the cylinder.

### Third Preferred Embodiment

In this third embodiment, all the components of the system of the invention are the same with the exception of the control module. Some older cars use a separate steering boss between the outer steering column tube and the steering wheel. This boss may be replaced by a boss according to the invention, which is in two contra-rotating parts and incorporates a potentiometer. One outer part, conforming substantially to the configuration of the original boss, is fixed to the column tube, with the other responsive to the turning of the steering wheel. The relative rotation between the two contra-rotating parts is limited, for example, to 20 degrees, and is spring loaded with centralizing springs to return to the central position, such that movement from the central position is limited to ten degrees in either direction.

The potentiometer responds to the relative movement between the 2 parts. The harder the wheel 10 is turned against the steering resistance, the more the centralizing springs, and accordingly the potentiometer are deflected, and the more the pump pumps. When force is removed, the potentiometer deflection ceases and the pump stops operating.

In conjunction with any of the above embodiments, the system of the invention provides one or more safety provisions which prevent the inadvertent operation of the hydraulic cylinder acting on the steering system of the vehicle.

For example, power may be denied to initiate operation of the control module 23 and other system components unless the vehicle is stationary and the brakes are applied.

Alternatively, the system may be arranged to only be operative if first or reverse gear is engaged. Or again, a control linkage to the speedometer cable may prevent activation of, or cessation of the operation of, the steering hydraulics at speeds over some desired safe maximum.

### In Use

The system of the invention allows a driver to activate the power steering assist when needing to maneuver a vintage vehicle at low speed, when parking or turning the vehicle around in a confined area for example. The control module 23 allows for selection of the direction in which the front wheels need to be turned, as well as the rate at which the driver wishes this to occur.

In one arrangement, the control module 23, may take the form of a slide potentiometer, spring loaded to return to the central position, operable in two opposing directions reflecting a left and right turns. The further the slide of the control module is displaced in either direction, the faster the speed of the electric motor driving the hydraulic pump, thus increasing both the pressure within the hydraulic circuit and the power and speed of response of the double acting hydraulic cylinder on the track rod of the vehicle's steering system.

More preferably with reference to FIG. 5, the control module utilises a conventional spinner knob 50 which is typically mounted to the rim 52 of a steering wheel 10. Such knobs axe found on the rims of steering wheels of buses, tractors and the like. The conventional mounting has the shaft about which the knob spins mounted parallel to the steering column shaft axis, and rigidly attached to said steering wheel rim 52.

In this preferred embodiment, the spinner knob shaft 56 is not rigidly attached to the steering wheel rim 52. Instead, it is attached to a bracket 54, which is pivotally attached to a further bracket 55 rigidly attached to the steering wheel rim, with the pivot axis 58 also being parallel to the steering column shaft 11 and spinner knob shaft 56.

The amount of rotation between the two brackets 54 and 55 is limited by stops to approximately 40 degrees, and is spring loaded so as to return the pivotally mounted bracket 55 to a centered, default neutral position when no transverse or tangential load is applied to the spinner knob 50.

Hence, when a transverse load is applied to the spinner knob 50, in the desired direction of rotation of the steering wheel 11, the pivotally attached bracket 55 will pivot and compress the centering springs (not shown) to an extent after which the steering wheel 10 will commence to rotate. The spinner knob 50 itself is completely free to rotate about its shaft 56.

Rotational movement of the pivotally attached bracket 55 can be used to rotate the input shaft of a rotary potentiometer 26. When the potentiometer 26 is in its central position, the bi-directional motor controller 22 does not direct any electrical current to the pump 23.

Pushing the spinner knob 50 clockwise or anticlockwise pushes the bracket 55 and determines the direction of activation of the steering system. The force with which the knob is pushed will determine the amount of deflection of the bracket 55 against the spring resistance and therefore of the potentiometer 26, which will determine the amount of electrical current to be sent from the bi-directional motor controller 22 to, and therefore the speed at which the pump 20 will operate and cylinder 21 extend or retract.

In all the above described embodiments or arrangements, the torque/force sensing device is attached to the rim, spokes or boss of the steering wheel. In prior art retrofittable power steering arrangements, the desired torque/force sensing device is. mounted in the steering column, steering gear box, or some other part of the steering system between the steering gear box and the steerable wheels.

It will be understood that other arrangements for providing control are envisaged, including pivotally mounting a lever under (or above) one of the typically flat spokes of the steering wheel, the lever being broad enough to project past the opposite edges of the spoke so that it may be deflected against a centralizing spring force in either direction by application of a driver's thumb or finger for example, and thereby operating eg a potentiometer.

In still another arrangement, the control module could be in the form of a single axis displacement joystick potentiometer, mounted on a spoke of a steering wheel, and situated such that the displacement axis is tangential to the direction of rotation of the steering wheel.

In still another arrangement, the control module, which may be steering wheel mounted, may be in the form of an isometric force joystick potentiometer. These devices are non-displacing or allow of only limited displacement when force is applied but are sensitive to the force and provide electrical output accordingly. Such a device could be mounted so as to be adjacent to the rim of a steering wheel, parallel to the steering column, and perpendicular to the rim, with a spinner knob mounted so that the joystick shaft also comprises, or is coaxial with, the spinner knob shaft.

In each of the above examples, the preferred arrangement is that the control module is biased to return to a neutral default central position when released, thereby cutting power to the hydraulic pump 20 and solenoid valve 24, returning the valve to its default open position. When returned to this neutral position with the pump deactivated and the solenoid valve open, the steering system is returned to full manual control.

By adapting most, if not all, the components for mounting to the vehicle by means of attachment clamps, or brackets which can be bolted to the vehicle, no part of the original steering system is modified in any substantial way. Thus the system can readily be removed from the vehicle to restore it to its original condition.

### Alternative Embodiments

The example embodiment is fitted with a valve, known in the art as a normally open solenoid valve. This valve is fitted for safety reasons. In an alternative embodiment other methods of providing safety can be fitted, including but not limited to a manual override lever to release the system.

The example embodiment uses wired systems to communicate between the various components. An alternative embodiment could include wireless technologies as the basis of communication.

The example embodiment shows the double acting hydraulic cylinder connecting to the track rod. In an alternative embodiment the placement of this cylinder can be adjusted to suit various steering systems.

The example embodiment uses hydraulics to actuate the steering system. An alternative embodiment could use a pneumatic system or an electric system.

The example embodiment shows what are considered to be the core components necessary for the system to function. Additional parts may be used in alternative embodiments.

The example embodiment shows the control module mounted on the steering wheel. This module could be mounted in a different location. The control module could be connected to a steering wheel spinner knob, a joy stick, a potentiometer, or a combination of same.

The example embodiment uses an electronic control module. An alternative embodiment could use an hydraulic or pneumatic control valve.

The example embodiment is shown as fitted to the track rod of a Pitman arm steering system. In an alternative embodiment this could be connected to any part of such a system which moves when the steering wheel is turned.

In an alternative embodiment this system can be fitted to other steering systems including, but not limited to rack and pinion type steering systems.

The above describes only some embodiments of the present invention and modifications, obvious to those skilled in the art, can be made thereto without departing from the scope and spirit of the present invention.

1. A power steering system for retrofitting to an original steering system of a non-power assisted steering vehicle; said system including an actuator acting on a component of the original steering system of a said vehicle downstream of a steering box of said original steering system or between said steering box or a gear and steerable wheels of said vehicle; said system characterised in that said power steering system is activated manually under driver control; said driver control comprising a torque/force sensing control module mounted to a steering wheel of said vehicle; said control module being operated by said driver applying force directly to said module and not said steering wheel; said control module moving with said steering wheel; said system further characterised in that original steering components of said vehicle remain un-modified.

2. The system of claim 1 wherein components of said system are removably attached to said vehicle by clamping means.

3. The system of claim 1 wherein said system includes said torque/force sensing control module, a power source and said actuator.

4. The system of claim 1 wherein said torque/force sensing control module is affixed to a rim, or on one or more spokes or a central boss of the steering wheel of said vehicle.

5. The system of claim 3 wherein said power source comprises an electrical power supply source and a reversible electro-hydraulic pump.

6. The system of claim 3 wherein said actuator is a double acting hydraulic cylinder; said cylinder mounted between a non-steering component and a steering component of said vehicle.

7. The system of claim 6 wherein an outer end of a piston rod of said double acting hydraulic cylinder is clamped to said steering component.

8. The system of claim 6 wherein a rear end of said hydraulic cylinder is pivotally attached to a fixture clamped to a chassis member of said vehicle.

9. The system of claim 6 wherein a rear end of said hydraulic cylinder is pivotally attached to a bracket extending from a front axle of said vehicle wherein the steerable wheels of said vehicle are not independently suspended and are connected by a rigid axle.

10. The system of claims 3-9 wherein said control module activates said reversible electro-hydraulic pump.

11. The system of claim 5 wherein said system further includes one way “check” valves which prevent hydraulic fluid escaping from said cylinder and a normally open hydraulic solenoid valve interconnecting respective hydraulic hoses between said electro-hydraulic pump and said double acting hydraulic cylinder.

12. The system of claim 5 to wherein said electro-hydraulic pump and said double acting hydraulic cylinder form a closed circuit hydraulic system when said normally open solenoid is closed.

13. The system of claim 5 wherein said torque/force sensing control module provides for variable bi-directional speed control of said electro-hydraulic pump to provide respectively left and right turning of the front wheels of said vehicle; said control module biased towards a neutral default position in which electrical power is cut to said hydraulic pump and said normally open solenoid valve.

14. The system described in claim 13 wherein said biasing towards a neutral position is such that a force applied to said module tangentially to the direction of rotation of the steering wheel determines the direction and speed of movement of said cylinder.

15. The system of claim 5 wherein an override switch maintains electrical power to said normally open solenoid valve; said valve then maintained in a closed position so as to lock said hydraulic cylinder into a partially or fully extended or partially or fully retracted position when turning a said vehicle at low speed.

16. A method of retro-fitting a power steering system to a steering system of a vehicle; the method including the steps of:
(a) mounting a double acting linear actuator between a component of the steering system of said vehicle and an element of said vehicle other than a said component of said steering system,
(b) providing a manual control to activate a bi-directional power source for said double acting linear actuator,
and wherein said manual control comprises a torque/force sensing device mounted to, or adjacent to, a steering wheel of said vehicle and wherein all components of said system are attached to said steering component and
(c) a chassis or
(d) where the front wheels of said vehicle are not independently suspended, the front axle.

17. The method of claim 16 wherein said double acting linear actuator is a double acting hydraulic cylinder; said double acting hydraulic cylinder mounted between a chassis member or front axle and a track rod of said vehicle; extension and retraction of a piston rod of said hydraulic cylinder acting on said track rod to turn the front wheels of said vehicle when steering.

18. The method of claim 16 wherein said bi-directional power source is a variable speed electro-hydraulic pump; said pump and said double acting hydraulic cylinder forming an hydraulic circuit.

19. The method of claim 18 wherein said hydraulic circuit further includes a normally open solenoid valve; said solenoid valve providing a fluid passage between hydraulic hoses connecting said pump and said double acting hydraulic cylinder when said solenoid valve is in a default open position; said normally open solenoid valve closing when power is provided to said solenoid valve thereby creating a closed hydraulic circuit between said pump and said double action hydraulic cylinder.

20. The method of claim 18 wherein said variable speed electro-hydraulic pump is manually controlled by a control module; said control module operable in opposing directions so as to control extension and retraction of a piston rod of said double acting hydraulic cylinder acting on a track rod of said steering system.

21. A power assistance system for vintage or older vehicles; said system including a pressurised hydraulic fluid source and at least an hydraulic cylinder acting on a steering component of a said vintage or older vehicle; said system further including a driver operated control module comprising a torque/force sensing device mounted to, or adjacent to, a steering wheel of said vehicle; said pressurised hydraulic fluid source providing power for assistance to operation of brakes and clutch of said vehicle.

22-32. (canceled)
